(19) United States
(12) Patent Application Publication
(10) Pub. No.: US 2016/0102808 A1
(43) Pub. Date: Apr. 14, 2016

(54) Holding Fixture for Monitoring Device

(71) Applicant: ThyssenKrupp Elevator Corporation, Atlanta, GA (US)

(72) Inventors: Michael Bray, Sandy Springs, GA (US); Christian Breite, Ilmenau (DE)

(21) Appl. No.: 14/512,860

(22) Filed: Oct. 13, 2014

(51) Int. Cl. F16M 13/02; F16B 47/00

(52) U.S. Cl. CPC F16M 13/022; F16B 47/00

(57) ABSTRACT

A holding assembly releasably attaches a monitoring device to a surface of an elevator system for monitoring conditions of the elevator system. The holding assembly includes a platform body coupled to the monitoring device. A suction cup is coupled with the platform body to affix the platform body with the surface of the elevator system to be monitored. A plurality of protrusions extend from the platform body and are held by the suction cup against the surface of the elevator system to be monitored so as to transmit, through the protrusions, vibrational energy from the elevator system to the monitoring device.

### BACKGROUND

With some elevator systems, monitoring or sensing devices and/or systems can be used to monitor the elevator system. Monitoring may be directed to parameters for improving ride quality, parameters for diagnostic testing, etc. Regardless of the purpose or intent behind the monitoring it is desirable that the monitoring or sensing device and/or system be configured for use in a way that ensures good and reliable data is captured by the sensing device and/or system. While a variety of monitoring or sensing devices and/or systems have been made and used, it is believed that no one prior to the inventor(s) has made or used an invention as described herein.

### SUMMARY

In some embodiments described herein, a monitoring or sensing device and/or system is portable and can comprise a smart device, which can include, but is not limited to, a smart phone, a tablet computing device, a laptop, other computing device, etc. With such smart devices, to achieve quality and reliable data, a holding fixture is used to connect the smart device to a part or surface of the elevator system. Accordingly, described herein are embodiments of holding fixtures for smart devices for use with an elevator system where the holding fixtures function to provide a connection between the smart device and the elevator system so that quality and reliable monitoring data is obtained. In some embodiments, the holding fixture is connected to the elevator system by means of a releasable attachment. In other embodiments, the holding fixture is connected to the elevator system merely by situating the holding fixture on a relatively horizontal surface of the elevator system (e.g. cab floor).

In some embodiments, a holding assembly for releasably attaching a monitoring device to a surface of an elevator system to monitor performance of the elevator system comprises a magnetic portion configured to selectively connect the holding assembly with the monitoring device, and a suction cup configured to selectively attach the holding assembly with the surface of the elevator system. In some embodiments, the holding assembly includes an adjusting feature that alters the spacing of the suction cup relative to the surface of the elevator system to selectively activate the suction cup to connect with the surface of the elevator system. In some embodiments, the holding assembly includes one or more extension members configured to contact the surface of the elevator system and transmit vibrational energy from the elevator system to the monitoring device.

In some embodiments, a holder for selectively connecting a monitoring device to a surface of an elevator system to detect performance parameters of the elevator system comprises an attachment member configured to selectively connect the holder with the monitoring device, a platform member configured to connect the holder with the surface of the elevator system. In some embodiments, the platform member includes at least one extension member configured to contact the surface of the elevator system and transmit vibrational energy from the elevator system to the monitoring device.

In some embodiments, a method for using a monitoring device to monitor performance parameters of an elevator system comprises releasably mounting the monitoring device to an attachment member of a holder and positioning a platform member of the holder so that at least one extension member contacts a surface of the elevator system.

In some embodiments, a method for using a monitoring device with a holding assembly that has a platform portion and a holding portion to monitor performance parameters of an elevator system comprises aligning one or more extension members of the platform portion of the holding assembly with a surface of the elevator system, actuating an adjusting feature of the mounting portion to selectively attach a suction cup of the platform portion with the surface of the elevator system, and coupling the holding portion with the mounting portion through a magnetic connection.

### BRIEF DESCRIPTION OF THE DRAWINGS

While the specification concludes with claims which particularly point out and distinctly claim the invention, it is believed the present invention will be better understood from the following description of certain embodiments taken in conjunction with the accompanying drawings, in which like reference numerals identify the same elements.

FIG. 1 depicts a perspective view of an embodiment of a holding assembly for a smart device.

FIG. 2 depicts a front view of an embodiment of a platform device of the holding assembly of FIG. 1.

FIG. 3 depicts a side view of an embodiment of a body of the platform device of FIG. 2.

FIG. 4 depicts a bottom view of an embodiment of the body of FIG. 3.

FIG. 5 depicts a side view of an alternative embodiment of the platform device of the holding assembly of FIG. 1.

FIG. 6 depicts an alternative embodiment of the holding assembly.

FIG. 7 depicts a partially exploded view of the platform device of the holding assembly of FIG. 6.

FIG. 8 depicts a perspective view of an embodiment of a holding device of the holding assembly of FIG. 1.

FIG. 9 depicts a rear view of the holding device of FIG. 8.

FIG. 10A depicts a front view of the holding device of FIG. 8 in an open position.

FIG. 10B depicts a front view of the holding device of FIG. 8 in a closed position.

FIG. 11A depicts a front view of an embodiment of a platform device of the holding assembly of FIG. 1 in a first position.

FIG. 11B depicts a front view of an embodiment of a platform device of the holding assembly of FIG. 1 a second position.

FIG. 12A depicts a side view of the holding assembly of FIG. 1 in the first position shown in FIG. 11A.

FIG. 12B depicts a side plan view of the holding assembly of FIG. 1 in the second position shown in FIG. 11B.

FIG. 13A depicts a perspective view of an embodiment of a suction subassembly of the holding assembly of FIG. 1.

FIG. 13B depicts a cross-sectional view of the suction subassembly of FIG. 13A taken generally along line A-A.

The drawings are not intended to be limiting in any way, and it is contemplated that different embodiments may be carried out in other ways, including those not necessarily depicted in the drawings. The accompanying drawings illustrate several aspects of the present invention, and with the description serve to explain the principles of the invention. The present invention is not limited to the precise arrangements shown.

### DETAILED DESCRIPTION

The following description of certain embodiments of the invention should not be used to limit the scope of the present invention. Other examples, features, aspects, embodiments, and advantages of the invention will become apparent to those skilled in the art from the following description. As will be realized, various aspects of the present disclosure may take alternate forms, or have alternate or additional embodiments, without departing from the scope of the present disclosure. Accordingly, the drawings and descriptions should be regarded as illustrative in nature and not restrictive.

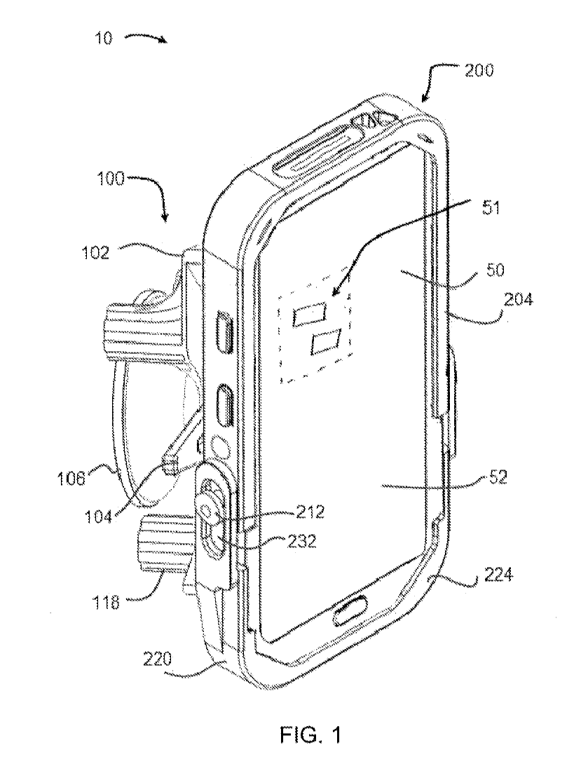

FIG. 1 depicts a perspective view of an embodiment of a holding assembly (10) for a smart device (50). Holding assembly (10) is configured to provide a reliable connection between smart device (50) (and its associated sensor(s) (51)) and a part or surface of an elevator system. This connection aides in providing good and reliable data capture. The sensor(s) (51) of smart device (50) can be housed within smart device (50) as depicted, or the sensor(s) (51) can be coupled with the exterior of smart device (50). Smart device (50) can be a smart cell phone, a tablet, a personal computer, or other electronic controller connected with sensors (51).

The part of the elevator system to which holding assembly (10) is connected may be referred to herein as the “monitored part of the elevator system,” the “monitored part,” or other similar terms. These terms should be construed broadly and do not restrict the smart device's (50) monitoring ability to only those structures or components to which the holding assembly (10) is directly connected with. In other words, structures and components monitored may include those to which smart device (50) is directly connected to by way of holding assembly (10), as well as those to which smart device (50) is indirectly connected to by way of holding assembly (10).

Holding assembly (10) can be configured to releasably attach smart device (50) with any part of the elevator system, machinery, or building. For example, holding assembly (10) can be connected to an elevator car surface, drives, generators, gears, bearings, or other suitable parts that are desired to be monitored. Holding device (10) is configured to be releasably coupled to a monitored part of the elevator system without damaging the elevator system. By way of example only, and not limitation, holding device (10) is releasably attached to a wall of the elevator car without drilling holes into the wall. Using smart device (50) and holding assembly (10), the elevator system can be monitored for parameters including but not limited to vibration, speed, acceleration, deceleration, jerk, stiffness, weight, or other performance measurements.

As shown in FIG. 1, holding assembly (10) comprises a platform device (100) and a holding device (200) releasably coupled with platform device (100). Holding device (200) is configured to hold smart device (50), while platform device (100) is configured to releasably attach holding device (200) and smart device (50) to a monitored part of an elevator system. In this embodiment, holding assembly (10) comprises a multi-part construction that permits the smart device (50) to be selectively attachable to a surface of a monitored part of the elevator system by means of a suction cup (106), without completely detaching the entire holding assembly (10) from the surface of the monitored part. Furthermore, holding assembly (10) is configured to provide a selective and repeatable attachment to a surface of a monitored part though use of its multi-part construction. These and other features and aspects of holding assembly (10) will be described further below.

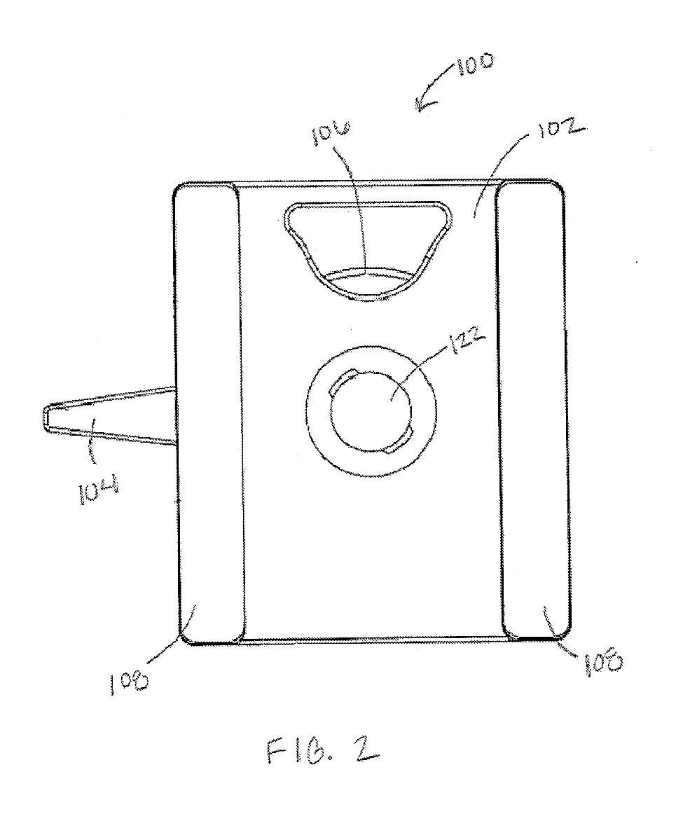

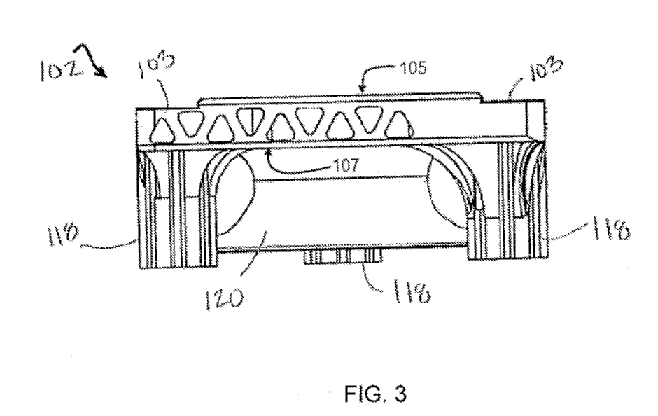

Platform device (100) is shown in more detail in FIG. 2. Platform device (100) comprises a body (102), a pair of magnets (108), a lever (104), and a suction cup (106). As best seen in FIG. 3, body (102) of platform device (100) comprises a first surface (105) having a pair of recesses (103) to receive a magnet (108) in each recess (103). Magnets (108) are configured to maintain the position of holding device (200) relative to body (102) of platform device (100) during operation of the elevator system as described further below. In the present embodiment, magnets (108) comprise permanent magnets. In some embodiments, magnets (108) can be rare earth magnets. While FIG. 2 shows platform device (100) comprising two magnets (108), any other suitable number of magnets (108) can be used. Other suitable configurations, types, and numbers for magnets (108) will be apparent to one with ordinary skill in the art in view of the teachings herein.

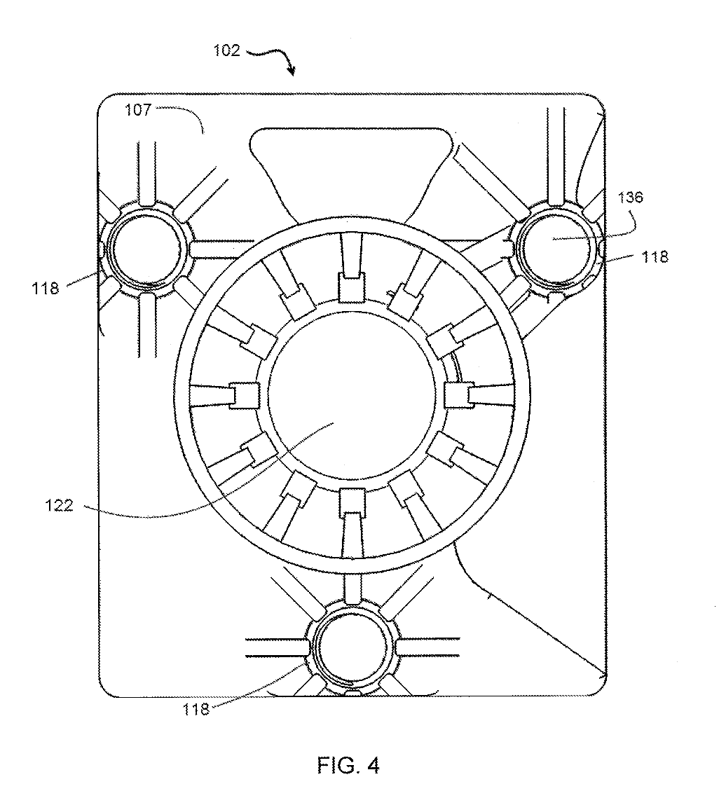

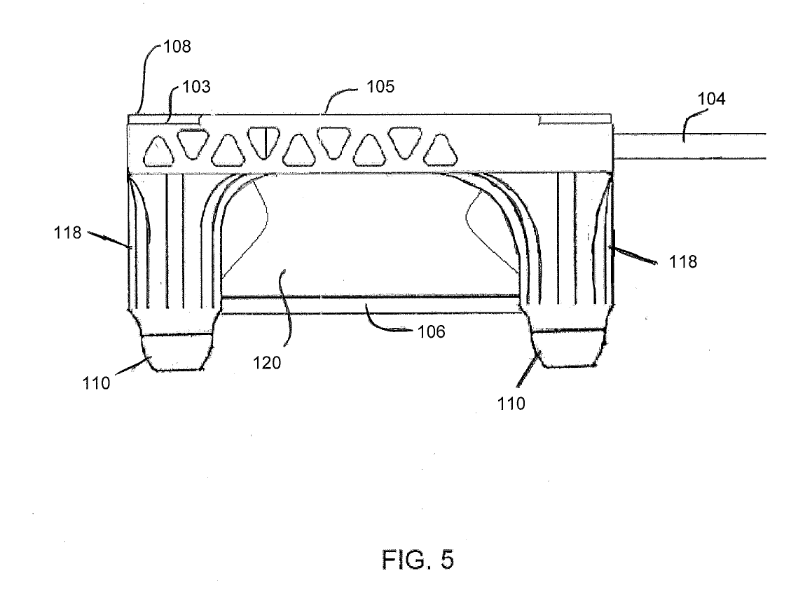

Body (102) further comprises a second, opposing surface (107), a cover (120), and an opening (122). Protrusions (118) extend outwardly from the second, opposing surface (107). In some embodiments, each protrusion (118) of body (102) defines an opening (136) as seen in FIG. 4. In other embodiments, each protrusion terminates into a tip (110) as seen in FIG. 5. Protrusions (118), either alone or in combination with tips or legs disposed at the end thereof, are configured to maintain contact with the monitored part such that protrusions (118) transmit vibrations occurring within the elevator system through platform device (100) to the sensors (51) of smart device (50). With this configuration, protrusions (118) decrease or avoid dampening influences that may be attributable to other features of holding assembly (10). In the present embodiment, without the use of protrusions (118), the only connection between smart device (50) and monitored part would be by way of suction cup (106). Due to the construction and nature of suction cup (106), suction cup (106) can have a dampening effect and thus hinder transmission of vibrational energy from the elevator system to the sensor(s) (51) of smart device (50). Thus, the use of protrusions (118) provides a less dampened pathway to transmit vibrational energy from the elevator system to the sensor(s) (51) and thus improves the quality and reliability of the data captured using smart device (50).

Platform device (100) further comprises a lever (104). In some embodiments, lever (104) is used as a handle to pry suction cup (106) from the monitored part thereby releasing platform device (100) from the monitored part. In other embodiments, with the platform device (100) held tightly against an attachment surface of the monitored part, the lever (104) can be rotated in a first direction to extend the suction cup (106) away from the platform device (100) and force the suction cup (106) against the surface of the monitored part to create a vacuum seal between the suction cup and the attachment surface of the monitored part. With the suction cup vacuum sealed to a surface of the monitored part, the lever (104) can be rotated in a second direction to retract the suction cup (106) away from the surface of the monitored part. In some embodiments, continued rotation of the lever (104) in the second direction will retract the suction cup toward the platform device (100) and away from the attachment surface of the monitored part so as to partially or fully release the vacuum seal of the suction cup (106). The release of the vacuum releases platform device (100) from the monitored part. In other embodiments, lever (104) can be ratcheted or have a ratcheting action relative to the body (102) to translate suction cup (106) away from or towards the platform device (100). In yet other embodiments, lever (104) is absent from the platform device (100).

Platform device (100) can be manufactured by 3D printing, injection molding, extrusion, and other suitable manufacturing techniques, and may be made from rigid or semi-rigid plastics or other polymers, metal or metal alloys, and other suitable materials that possess a sufficient structural rigidity and stiffness to transmit substantially un-damped vibrations to the sensing device coupled thereto, without departing from the scope of the present disclosure. Other embodiments and configurations of platform device (100) and ways to manufacture platform device (100) will be apparent to one of ordinary skill in the art in view of the teachings herein. Suction cup (106) can be made of rubber, silicone, or other suitable material. While FIGS. 1-3 show that one suction cup (106) is used in platform device (100), more than one suction cup (106) can be used in other embodiments. As best seen in FIG. 3, body (102) includes three protrusions (118). Of course, greater or fewer number of protrusions (118) or other suitable configurations for protrusions (118) will be apparent to one with ordinary skill in the art in view of the teachings herein.

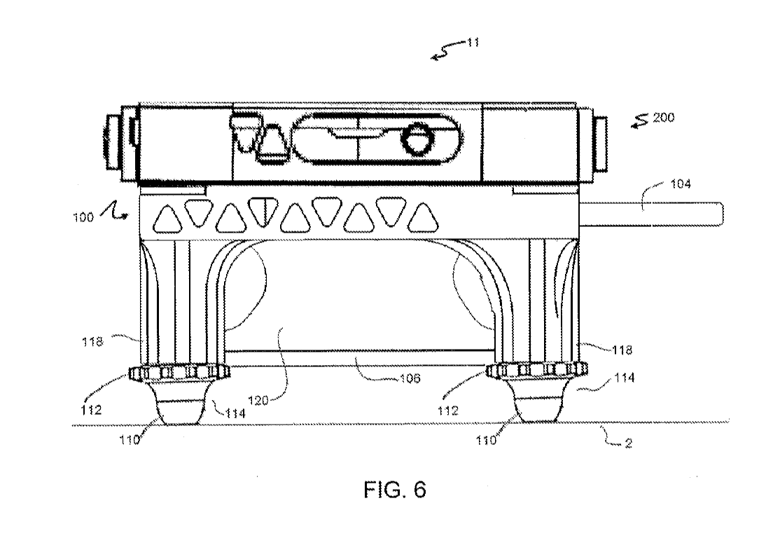

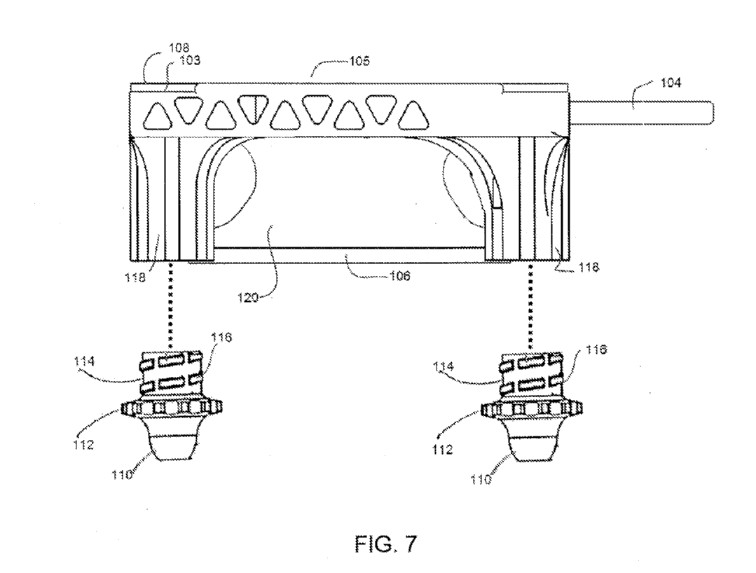

FIGS. 6-7 show an alternative embodiment of a holding assembly (11). In the present embodiment, each protrusion (118) of body (102) defines an opening (136) as seen in FIG. 4 configured to receive a leg (114). The legs (114) of monitoring assembly (11) are selectively removable. When legs (114) are detached from protrusions (118), holding device (11) may be releasably attached to a monitored part of an elevator system by means of suction cup (106). Protrusions (118) maintain contact with the monitored part such that protrusions (114) transmit vibrations occurring within the elevator system through mounting device (100) to the sensors (51) of smart device (50). When legs (114) are attached to protrusions (118), holding device (11) may be connected to the elevator system by situating the holding assembly (11) on horizontal surface (2) of the elevator system (e.g. cab floor). Legs (114) are configured to maintain contact with horizontal surface (2) such that legs (114) transmit vibrations occurring within the elevator system to the sensors (51) of smart device (50). Legs (114) ensure that the holding assembly (11) imposes minimum pressure between the holding assembly (11) and the horizontal surface (2). When legs (114) are attached to protrusions (118), the suction cup (106) does not contact, or rest on, the monitored part or surface of the elevator system when in a non-extended position. The holding assembly (11) adheres to ISO standards while collecting ride data when legs (114) are attached to protrusions (118) and the holding assembly (11) is situated at the center of an elevator cab floor.

Referring to FIG. 7, each leg (114) comprises ridges (116), an annular flange (112), and a tip (110). In one embodiment, leg (114) inserts within the opening of protrusion (118) of body (102) until annular flange (112) contacts a bottom surface of protrusion (118). Ridges (116) of leg (114) are positioned within protrusion (118) and tip (110) extends from protrusions (118) of body (102). In one embodiment, a leg (114) is press fit into each opening disposed in the bottom of each of the protrusions (118). In such embodiment, the ridges (116) provide a friction fit or interference fit against an interior surface of the openings of protrusions (118) to hold legs (114) within protrusions (118), such that legs (114) are fixed relative to protrusions (118) and body (102). The platform device (100) is then positioned such that the tips (110) extending from the ends of the protrusions (118) rest on a substantially horizontal surface (2) of the part to be monitored (e.g. a floor of an elevator cab), such that tips (110) maintain connection or contact with the monitored part. In an alternate embodiment, the ridges (116) of legs (114) have a threaded pattern such that ridges (116) comprise threads that threadably engage openings in protrusions (118). Openings (134) of protrusions (118) have corresponding threaded portions to receive the threads of ridges (116). This threaded engagement can provide the ability to adjust the amount that legs (114) extend from protrusions (118) and body (102).

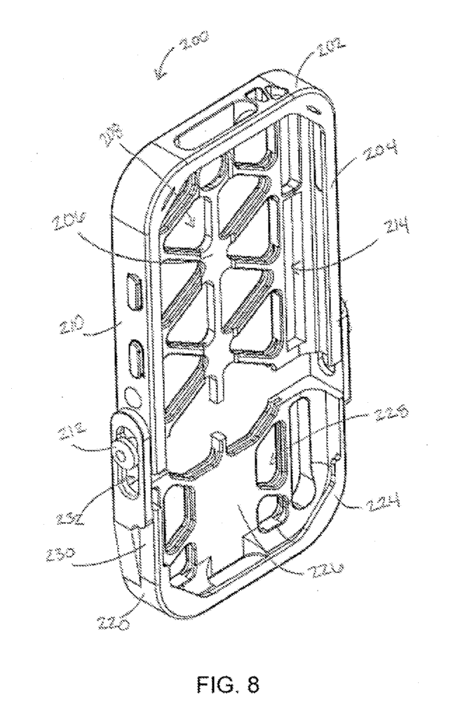

In the embodiments described above, platform device (100) is releasably coupled with holding device (200). In some embodiments, platform device (100) may be mounted to a monitored part of the elevator system prior to coupling platform device (100) with holding device (200). In some other embodiments, platform device (100) may be coupled with holding device (200) prior to platform device (100) being mounted to a monitored part of the elevator system. FIGS. 8-9 show an embodiment of the holding device (200) in more detail. In one embodiment, holding device (200) comprises a first body (202) and a second body (220) coupled with first body (202). First body (202) includes a wall (206) and a rim (204) coupled with wall (206) via side wall (210). Second body (220) also includes a second wall (226) and a second rim (224) coupled with second wall (226) via a second side wall (230). A pin (212) of first body (202) is inserted within an opening (232) of second body (220) to couple first body (202) with second body (220). Pin (212) and opening (232) allow second body (220) to be selectively translated relative to first body (202). Smart device (50) can thereby be positioned within holding device (200) when second body (220) is translated away from first body (202). Second body (220) is then translated toward first body (202) to hold smart device (200) within holding device (200). For example, smart device (50) is positioned against walls (206, 226) of bodies (202, 220) such that rims (204, 224) of bodies (202, 220) extend over a front face of smart device (50) to hold smart device (50) within holding device (200). In alternate embodiments of the holding device (200), first body (202) and second body (220) are stationary relative to each other and at least a portion of the holding device is elastically deformable such that smart device (50) is able to be snapped into holding device (200) due to the elastically resilient nature of rims (204, 224).

As best seen in FIG. 9, in one embodiment, a back surface of the wall (206) of first body (202) defines a pair of slots (214) that are configured to receive therein at least a portion of the magnets (108) that are coupled to platform device (100). The magnets (108) are attracted by magnetic forces to a metal back surface or other similar magnetic features of the smart device (50), and thereby hold the holding device (200) to platform device (100) via the magnetic coupling between magnets (108) of the platform device (100) and the metal back surface of the smart device (50). In some other embodiments, the material surrounding slots (214) of holding device (200) can be made of a ferromagnetic metal to secure holding device (200) to platform device (100) via the magnets (108). In still other alternate embodiments, slots (214) also include a second set of magnets disposed therein that are configured to be magnetically coupled to the magnets (108) of the platform device (100) so as to magnetically couple the holding device (200) to platform device (100).

As shown in the above described embodiments, slots (214) can extend partially or fully through wall (206) of holding device (200). Still other configurations of holding device (200) will be apparent to one with ordinary skill in the art in view of the teachings herein. For example, slots (214) can be positioned on second body (220) to receive platform device (100) or slots (214) can be positioned on platform device (100) such that magnets (108) are provided on holding device (200). Further, any other suitable number of magnets (108) and/or slots (214) can be used. Magnets (108) and/or slots (214) can also be any suitable shape (e.g., rectangular, square, circular, triangular, etc.).

Walls (206, 226) of holding device (200) further comprise openings (208, 228) defined therein. These openings (208, 228) can be used to decrease the weight of holding device (200) and/or to disengage or eject smart device (50) from holding device (200). It should be noted that openings (208, 228) are merely optional. Holding device (200) can also include other suitable shapes to receive a smart device (50). Holding device (200) can be manufactured using the same or similar techniques as described above for manufacturing platform device (100).

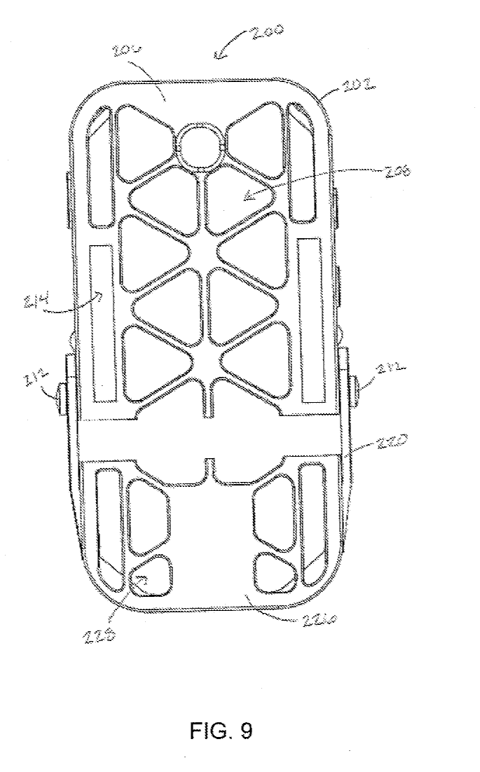

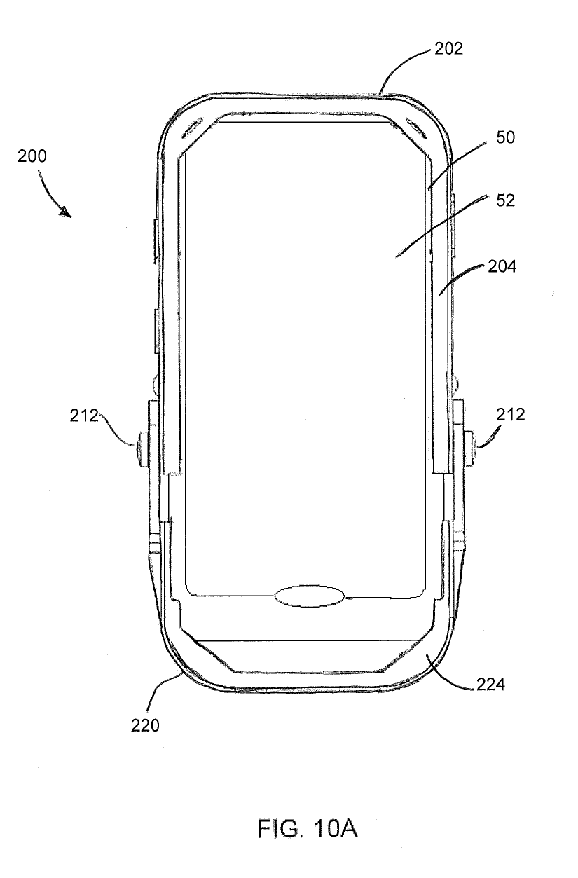

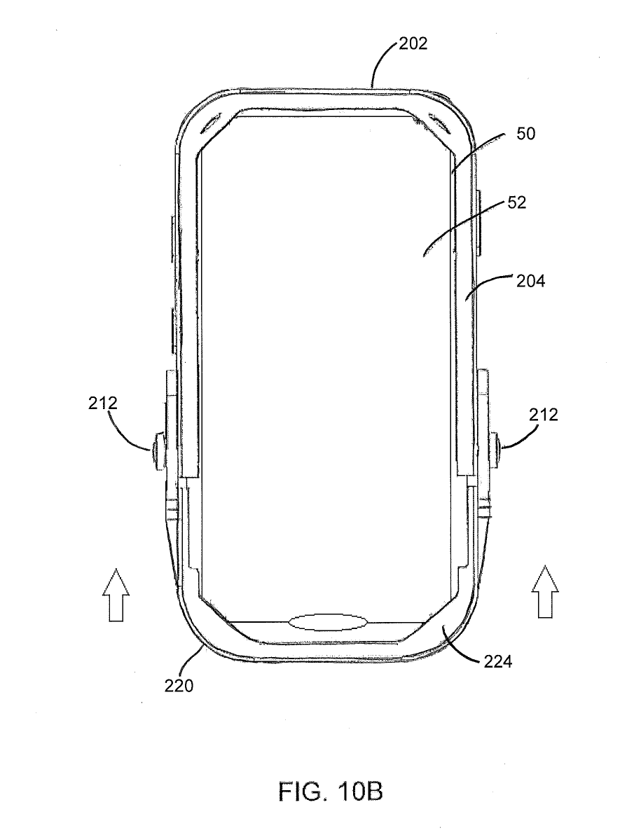

FIGS. 10A-10B show smart device (50) being coupled with holding device (200). FIG. 10A shows holding device (200) in an open position such that second body (220) of holding device (200) is translated away from first body (202). Smart device (50) is placed within and against walls (206, 226) of holding device (200) with a front face (52) of smart device (50) facing outwardly from holding device (200). Accordingly, where inputs of smart device (50) are on or part of front face (52), smart device (50) can be operated while smart device (50) is placed within holding device (200). Second body (220) is then translated toward first body (202) such that pin (212) translates within opening (232). Second body (220) thereby closes around smart device (50) to position rims (204, 224) of holding device (200) around smart device (50) to retain smart device (50) within holding device (200). Pins (212) can provide a friction fit with opening (232) to maintain the position of second body (220) relative to first body (202). In other embodiments, a smart device (50) may be snapped into the holding device (200) without the need to translate the bodies (202, 220) of the holding device (200) relative to each other. Other suitable methods for releasably securing smart device (50) within holding device (200) will be apparent to those with ordinary skill in the art in view of the teachings herein. For instance, each side of first body (202) may comprise a spherical cap or protruding bump that can prevent translation of second body (220) relative to first body (202) without external force via a friction fit. In some embodiments, each side of second body (220) can comprise a corresponding depression to receive the cap or bump of the first body (202) to further prevent the translation of second body (220) relative to first body (202) until an external force pushes the cap or bump of the first body (202) out of the depression of the second body (220).

With smart device (50) retained within holding device (200), in the present embodiment, holding device (200) can be coupled with platform device (200), as shown in FIG. 1. In particular, magnets (108) of platform device (100) are positioned within or against slots (214) of holding device (200) to releasably secure holding device (200) with platform device (100). For example, in the present embodiment, magnets (108) of platform device (100) magnetically connect with smart device (50) through holding device (200). This magnetic connection maintains the position of holding device (200) relative to platform device (100).

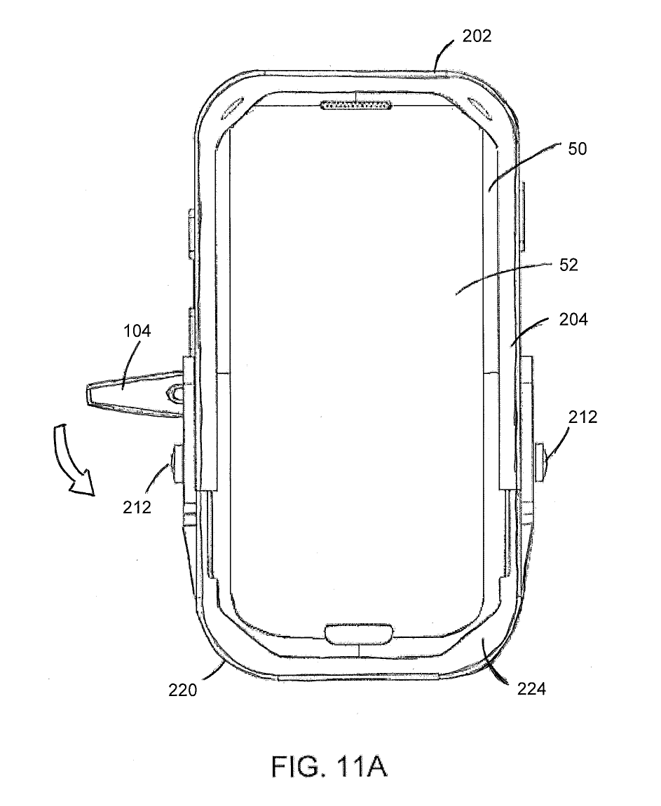

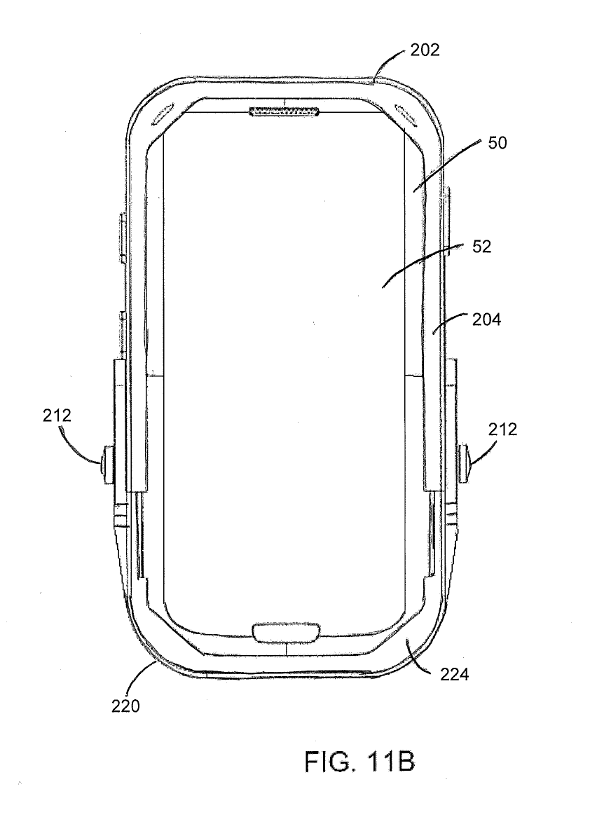

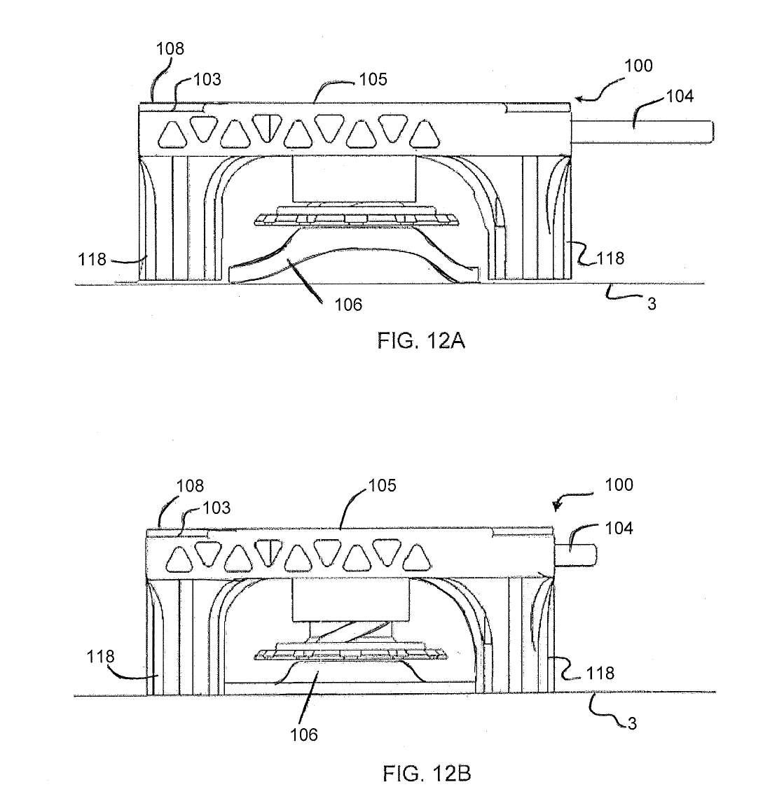

As mentioned above, in some embodiments of platform device (100), when the suction cup is suctioned to a part to be monitored, a rotatable lever (104) is at least partially configured, by movement of the suction cup (106), to adjust a magnitude of the vacuum pressure of the seal that exists between suction cup (106) and a monitored part, such as a wall of an elevator cab (3). As shown in FIG. 11A, platform device (100) is positioned in a first position with lever (104) of platform device (100) in an outward position. Suction cup (106) of platform device (100) is in a retracted position, as shown in FIG. 12A. Ends of protrusions (118) are placed on the surface of elevator cab wall (3) to position the outer edge of suction cup (106) on or near elevator cab wall (3). Lever (104) can then be actuated to extend suction cup (106) to secure suction cup (106) with elevator cab wall (3) as described in further detail below. In one embodiment, FIG. 11A shows an arrow indicating a direction of rotation for the lever (104) that will cause the suction cup (106) to extend from the platform device (100) for engagement with a surface of a part to be monitored. FIGS. 11B and 12B show the platform device (100) and lever (104) after the lever (104) has been rotated counter-clockwise with respect to the platform device (100), as viewed from the smart device side of the holding assembly (10). The rotation of lever (104) causes suction cup (106) to translate to an extended position away from platform device (100). While holding the platform device (100) firm against a surface of the elevator car wall to which it will be mounted, as suction cup (106) is extended via rotation of the lever (104), suction cup (106) presses against the surface of elevator car wall (3) and creates a vacuum with elevator car wall (3), as shown in FIG. 12B. This secures platform device (100) with elevator wall (3). In the secured position or state of FIGS. 11B and 12B, protrusions (118) press against elevator car wall (3) to provide secure contact between platform device (100) and the monitored part of the elevator.

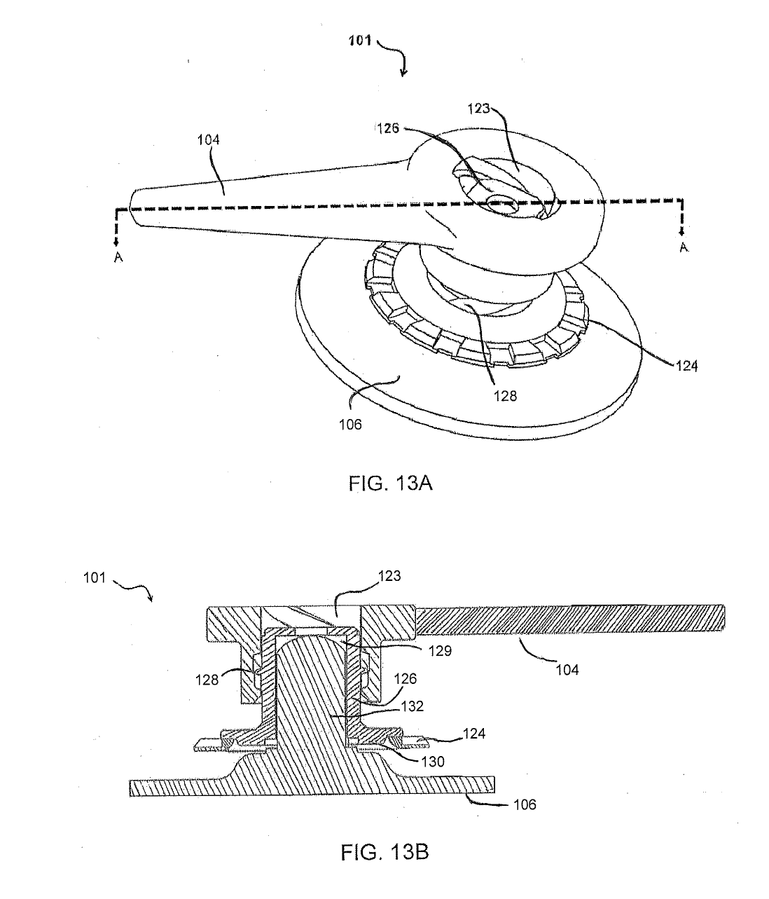

FIGS. 13A-13B respectively show a perspective view and a cutaway view of an embodiment of an adjustable suction subassembly (101) that is insertable within the opening (122) of body (102). Adjustable suction subassembly (101) comprises rotatable lever (104), suction cup (106), a suction cup extension (132), a screw (126), and a disk (124). A threaded opening (123) extends through the pivot axis of lever (104). Screw (126) comprises external threads (128) that correspond to threaded opening (123) such that a first end of screw (126) threadably engages with threaded opening (123). Suction cup extension (132) extends at least partially into a screw opening (129) in a second end of screw (126). In some embodiments, suction cup extension (132) is force fit into screw opening (129). In other embodiments, suction cup extension (132) is secured to screw opening (129) by an engagement of corresponding recesses and protrusions. Disk (124) is permanently attached to cover (120) of body (102) and captures a flange portion (130) of the second end of screw (126). Disk (124) only allows screw (126) to rotate minimally. Thus, disk (124) prevents the suction cup (106) from rotating and becoming separated from the platform device (100).

In operation, when lever (104) is rotated relative to the body (102) of the platform device (100), the screw (126) is translated to either extend away from or retract towards the body (102) of platform device (100). The extension or retraction of screw (126), in turn, forces both the suction cup extension (132) and the suction cup (106) to similarly extend away from or retract towards the body (102) of the platform device (100). In use, suction cup (106) is placed on a surface of the monitored part of the elevator system and is then extended relative to body (102) of platform device (100) to drive suction cup (106) toward the surface of the monitored part. Suction cup (106) is extendable and/or retractable relative to body (102) of platform device (100) by use of lever (104). Lever (104) is coupled to opening (122) of body (102) and is rotatable relative to body (102). In the present embodiment, lever (104) is rotated toward body (102) to rotate and extend screw (126) relative to body (102), although in other embodiments the rotation direction of lever (104) for extending screw (126) may be reversed. In response to rotation of lever (104), screw (126) translates to extend suction cup (106) toward a surface of the monitored part. With the platform device (100) held firmly against the surface of the monitored part by a user of the holding assembly (10), this translation of the screw (126) pushes or forces the suction cup (106) against the surface of the monitored part and creates a vacuum between suction cup (106) and the surface of the monitored part, thereby adhering platform device (100) to the surface of the monitored part. In the present embodiment, lever (104) can then be rotated in the opposing direction (e.g. in one embodiment, a clockwise direction with respect to the platform device (100), as viewed from the smart device side of the holding assembly (10)) so as to cause screw (126) to rotate and retract toward the platform device (100). This thereby also retracts suction cup (106), increasing the magnitude of vacuum pressure between the suction cup (106) and the surface of the monitored part to which the platform device (100) is mounted, thereby increasing the force by which the platform device (100) is adhered to the monitored part. Continued rotation of the lever (104) in the retraction direction further pulls the suction cup extension (132) away from the surface of the monitored part, such that the retraction force imparted on the suction cup extension (132) from the rotating lever (104) will exceed the holding force of the suction cup (106) and cause the suction cup to release the vacuum seal between the suction cup (106) and the monitored part. The release of the vacuum releases platform device (100) from the monitored part.

While the present embodiments have been described and shown using suction cup (106) to releasably attach platform device (100) to a monitoring part, other suitable methods for releasably attaching platform device (100) to a monitoring part, such as elevator car wall (3), will be apparent to one with ordinary skill in the art in view of the teachings herein. For instance, magnets may be used instead of suction cup (106) to couple platform device (100) to a ferromagnetic material of an elevator system. In other embodiments, platform device (100) attaches to elevator car wall (3) using van-der-waals forces between two different materials (e.g., by using a polymeric pad that can be part of platform device (100)). In still other versions, platform device (100) comprises an adhesive cover to adhere to the surface of elevator car wall (3). Such an adhesive cover can be a low strength adhesive such that platform device (100) can be removed from elevator car wall (3) without damaging elevator car wall (3). In some embodiments, platform device (100) is optional such that holding device (200) includes a suction cup (106), magnet, or other device to directly couple holding device (200) with elevator car wall (3). In other embodiments, holding device (200) is optional such that magnets (108) of platform device (100) are directly coupled with smart device (50).

Once smart device (50) is releasably attached to or appropriately situated on a monitored part by holding assembly (10), the elevator system can be operated to allow smart device (50) to gather the desired data. Smart device (50) can then be removed. In some embodiments, lever (104) can be rotated, ratcheted, or pulled to disengage suction cup (106) from the monitored part. Holding device (200) can then be pulled away from platform device (100) to release magnets (108) from slots (214). Smart device (50) is then removed from holding device (200). The second body (220) can be pulled away from first body (202) to release smart device (50). In other versions, smart device (50) is pushed out of holding device (200). Other suitable methods for removing smart device (50) from holding device (200) will be apparent to one with ordinary skill in the art in view of the teachings herein.

It should be understood that any one or more of the teachings, expressions, embodiments, examples, etc. disclosed herein may be combined with any one or more of the other teachings, expressions, embodiments, examples, etc. that are disclosed herein. The teachings, expressions, embodiments, examples, etc. disclosed herein should therefore not be viewed in isolation relative to each other. Various suitable ways in which numerous aspects of the present disclosure may be combined will be readily apparent to those of ordinary skill in the art in view of the teachings disclosed herein. Such modifications and variations are intended to be included within the scope of both the present disclosure and the claims.

Having shown and described various embodiments of the present disclosure, further adaptations of the methods and systems described herein may be accomplished by appropriate modifications by one of ordinary skill in the art without departing from the scope of the present disclosure. Several of such potential modifications have been mentioned, and others will be apparent to those skilled in the art. For instance, examples, embodiments, geometrics, materials, dimensions, ratios, steps, and the like discussed above are illustrative and are not required. Accordingly, the scope of the present disclosure should be considered in terms of the following claims and is understood not to be limited to the details of structure and operation shown and described in the specification and drawings.

I/We claim:

1. A holding assembly for releasably attaching a monitoring device to a surface of an elevator system for monitoring performance of the elevator system, the holding assembly comprising:
a platform body configured to be coupled to the monitoring device;
a suction cup coupled to said platform body and configured to affix said platform body to a surface of the elevator system to be monitored; and
a plurality of protrusions extending from said platform body and configured to be held by said suction cup against the surface of the elevator system to be monitored so as to transmit, through said protrusions, vibrational energy from the elevator system to the monitoring device.

2. The holding assembly of claim 1, wherein the plurality of protrusions are configured to have a rigid connection with the surface of the elevator system.

3. The holding assembly of claim 1, wherein each protrusion of the plurality of protrusions comprises an end having a tip configured to be positioned against the surface of the elevator system.

4. The holding assembly of claim 1, wherein each protrusion of the plurality of protrusions comprises an end defining an opening.

5. The holding assembly of claim 4, further comprising a leg selectively couplable with the opening of each protrusion of the plurality of protrusions.

6. The holding assembly of claim 5, wherein the leg comprises an annular flange configured to contact a bottom surface of the protrusion.

7. The holding assembly of claim 5, wherein the leg comprises a plurality of ridges configured to provide an interference fit with an interior surface of the opening.

8. The holding assembly of claim 1, further comprising an adjusting feature that alters the spacing of the suction cup relative to the surface of the elevator system to selectively activate the suction cup to connect with the surface of the elevator system.

9. The holding assembly of claim 8, wherein the adjusting feature comprises a lever.

10. The holding assembly of claim 9, wherein rotation of the lever causes translation of the suction cup.

11. The holding assembly of claim 1, wherein the holding assembly comprises a a holding device releasably coupled to the platform body, wherein the holding device is configured to retain the monitoring device.

12. The holding assembly of claim 11, wherein the platform body comprises a magnetic portion.

13. The holding assembly of claim 12, wherein the holding device releasably couples with the platform body indirectly through a magnetic connection between the magnetic portion of the platform device and the monitoring device retained within the holding device.

14. The holding assembly of claim 11, wherein the holding device comprises a first body and a second body, wherein the second body is translatable relative to the first body for retaining the monitoring device within the holding device.

15. A holder for selectively attaching a monitoring device to a surface of an elevator system to detect performance parameters of the elevator system, the holder comprising:
(a) a first attachment member configured to be selectively coupled to the monitoring device;
(b) a second attachment member configured to be selectively coupled to each of the first attachment member and the surface of the elevator system; and
(c) at least one extension member extending from at least one of said first or second attachment members and configured to contact the surface of the elevator system to transmit vibrational energy from the elevator system to the monitoring device.

16. The holder of claim 15, further comprising an adjusting feature disposed between said second attachment member and the surface of the elevator system, and configured to alter the spacing of the second attachment member relative to the surface of the elevator system so as to permit attachment of the second attachment member to the surface of the elevator system.

17. The holder of claim 15, wherein the at least at least one extension member comprises a leg configured to position the holder on a horizontal surface of the elevator system when the second attachment member is detached from the surface of the elevator system.

18. The holder of claim 15, wherein the second attachment member comprises a suction cup configured to selectively couple the second attachment member with the surface of the elevator system.

19. The holder of claim 15, wherein the holder is configured for use with a monitoring device comprising a smart device.

20. A method of using a monitoring device with a holding assembly comprising a mounting portion and a holding portion to monitor performance parameters of an elevator system, the method steps comprising:
(a) aligning one or more extension members of the mounting portion of the holding assembly with a surface of the elevator system;
(b) actuating an adjusting feature of the mounting portion to selectively attach a suction cup of the mounting portion with the surface of the elevator system; and
(c) coupling the holding portion with the mounting portion through a magnetic connection.
